(19) United States
(12) Patent Application Publication
(10) Pub. No.: US 2010/0103258 A1
(43) Pub. Date: Apr. 29, 2010

(54) CAMERA ARRANGEMENT AND METHOD FOR DETERMINING A RELATIVE POSITION OF A FIRST CAMERA WITH RESPECT TO A SECOND CAMERA

(75) Inventors: Ivan Moise, La Spezia (IT); Richard P. Kleihorst, Kasterlee (BE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/531,596

(22) PCT Filed: Mar. 17, 2008
(86) PCT No.: PCT/IB2008/051002

§ 371 Date: Sep. 16, 2009

(30) Foreign Application Priority Data
Mar. 21, 2007 (EP) 07104597.5

(51) Int. Cl. H04N 7/18

(52) U.S. Cl. 348/139; 348/E07.085

(57) ABSTRACT

A method for determining a relative position of a first camera with respect to a second camera, comprises the followings steps:
Determining at least a first, a second and a third position of respective reference points with respect to the first camera,
Determining at least a first, a second and a third distance of said respective reference points with respect to the second camera,
Calculating the relative position of the second camera with respect to the first camera using at least the first to the third positions and the first to the third distances.

### FIELD OF THE INVENTION

The present invention relates to a method for determining a relative position of a first camera with respect to a second camera.

The present invention further relates to a camera arrangement comprising a first camera, a second camera and a control node.

### BACKGROUND OF THE INVENTION

Recent technological advances enable a new generation of smart cameras that provide a high-level descriptions and an analysis of the captured scene. These devices could support a wide variety of applications including human and animal detection, surveillance, motion analysis, and facial identification. Such smart cameras are described for example by W. Wolf et. All. In “Smart cameras as embedded systems”, in Computer, vol. 35, no. 9, pp. 48-53, 2006.

To take full advantage of the images gathered from multiple vantage points it is helpful to know how such smart cameras in the scene are positioned and oriented with respect to each other.

### SUMMARY OF THE INVENTION

It is an aim of the invention to provide a method that allows determining a relative position of a first and a second camera while avoiding the use of separate position sensing devices. It is a further aim of the invention to provide a a camera arrangement comprising a first camera, a second camera and a control node that is capable of determining the relative position of the cameras while avoiding the use of separate position sensing devices.

According to the present invention these aims are achieved by a method as described according to claim 1 and a camera arrangement according to claim 2.

The present invention is based on the insight that the position of the cameras relative to each other can be calculated provided that the cameras have a shared field of view in which at least three common reference points are observed. In order to determine the relative position it suffices that the relative position (x₁,y₁); (x₂,y₂); (x₃; y₃) of those reference points with respect to a first one of the cameras is known, and that the relative distance d₁, d₂, d₃ of those reference points with respect to the other camera is known.

The relative positions of the reference points can be obtained using depth and angle information. The depth and the angle can be obtained using a stereo-camera. The relative position (xᵢ,yᵢ) of a reference point with depth dᵢ and angle θᵢ relative to a camera can be obtained by

xᵢ=dᵢ cos(θᵢ), and

yᵢ=dᵢ sin(θᵢ)

It is not important if the reference points are static points or are points observed of a moving object at subsequent instants of time. In an embodiment the reference points are for example bright spots arranged in space. Alternatively, it may be a single spot moving through space may form different reference points at different moments in time. Alternatively the reference points may be detected as characteristic features in the space, using a pattern recognition algorithm.

Knowing the three relative positions (x₁,y₁); (x₂,y₂); (x₃; y₃) with respect to the first camera and the depth information d₁, d₂, d₃ with respect to the second camera the relative position of the cameras with respect to each other can be calculated as follows.

In this calculation the following auxiliary terms are introduced to simplify the equations:

a₁=2x₂−2x₁

b₁=2y₂−2y₁

c₁=x₂²+y₂²−d₂²−x₁²−y₁²−d₁²

a₂=2x₃−2x₁

b₂=2y₃−2y₁

c₂=x₃²+y₃²−d₃²−x₁²−y₂²−d₁

The position (x_{c},y_{c}) of the second camera can now be computed using the following equations:

$${x}_{c} = \frac{{b}_{2} {c}_{1} - {b}_{1} {c}_{2}}{{a}_{1} {b}_{2} - {b}_{1} {a}_{2}} , \\ and$$

$${y}_{c} = \frac{{a}_{1} {c}_{2} - {a}_{2} {c}_{1}}{{a}_{1} {b}_{2} - {b}_{1} {a}_{2}}$$

Alternatively, the auxiliary terms may be avoided by substituting them in the equations for x_{c} and y_{c}.

Features in the images captured by the cameras may be recognized in a central node coupled to the cameras. In a preferred embodiment however, the cameras are smart cameras. This has the advantage that only a relatively small bandwidth is required for communication between the cameras and the central node.

In a preferred embodiment the camera arrangement is further arranged to calculated the relative orientation of the first and the second camera. The relative orientation can be calculated using in addition

### BRIEF DESCRIPTION OF THE DRAWINGS

These and other aspects of the present invention are described in more detail with reference to the drawing. Therein:

FIG. 1 schematically shows an arrangement of camera's having a common field of view,

FIG. 2 shows the definition of a world space using the position and orientation of a first camera,

FIG. 3 shows the local space of the first camera,

FIG. 4 shows the world space, having the first camera arranged in the origin and having its direction of view corresponding to the x-axis,

FIG. 5 shows the set of solutions for the possible position of a camera on the basis of the reference coordinates of a single reference point and one distance between the camera and that reference point,

FIG. 6 shows the set of solutions for the possible position of a camera on the basis of the reference coordinates for two reference points and the two distances between the camera and these reference points,

FIG. 7 shows the set of solutions for the possible position of a camera on the basis of the reference coordinates for three reference points and the three distances between the camera and these reference points,

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

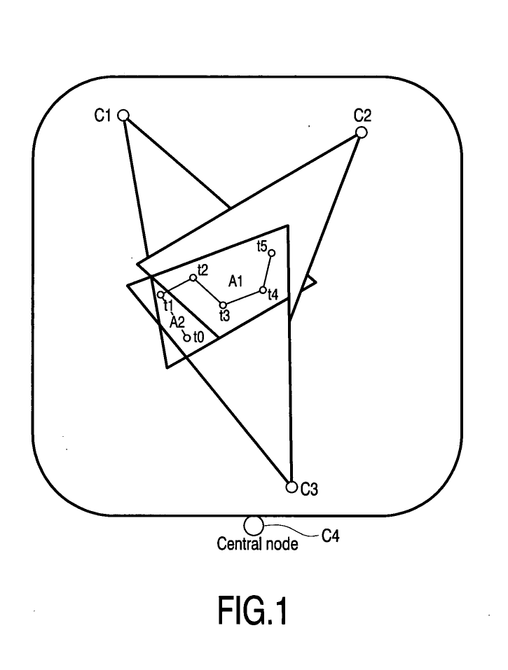

FIG. 1 shows an example network of 4 nodes, comprising three cameras C1, C2, C3, capable of object recognition and a central node C4. This node is responsible for synchronizing the other nodes of the network, receiving the data and building the 2D map of the sensors. In this embodiment the cameras C1, C2, C3 are smart cameras, capable of object recognition. The smart cameras report the detected object features as well as the depth and angle at which they are detected to the central node C4. In another embodiment however, the cameras transmit video information to the central node, and the central node performs object recognition using the video information received from the cameras. Object recognition may be relatively simple if an object is applied that is clearly distinguished from the background and having a simple shape, e.g. a bright light spot.

In FIG. 1 two areas are indicated: A1 and A2. A1 is seen by all the cameras in the network, while A2 is seen only by the cameras C1 and C3. The black path is an object moving in the area and the spots (t0, t1, . . . , t5) are the instants of time in which the position of the object is caught. Reference will be made to this picture in the description of the algorithm. The object caught is for example the face of a person walking through the room.

Without making any restriction it is presumed that all cameras already made the measurement of the angle of view and depth of the face detected, for each instant of time t0, t1, . . . , t5 and that all this in formation is already dispatched and stored in the central node. This data is displayed in Table 1:

TABLE 1
Data received from smart cameras.

| tⱼ | C1 | C2 | C3 |
|---|---|---|---|
| t₀ | (d_{C}_{₁},ₜ_{₀}, θ_{C}_{₁},ₜ_{₀}) | 0 | (d_{C}_{₃},ₜ_{₀}, θ_{C}_{₃},ₜ₀) |
| t₁ | (d_{C}_{₁},ₜ_{₁}, θ_{C}_{₁},ₜ_{₁}) | 0 | (d_{C}_{₃},ₜ_{₁}, θ_{C}_{₃},ₜ_{₁}) |
| t₂ | (d_{C}_{₁},ₜ_{₂}, θ_{C}_{₁},ₜ_{₂}) | (d_{C}_{₂},ₜ_{₂}, θ_{C}_{₂},ₜ_{₂}) | (d_{C}_{₃},ₜ_{₂}, θ_{C}_{₃},ₜ_{₂}) |
| t₃ | (d_{C}_{₁},ₜ_{₃}, θ_{C}_{₁},ₜ_{₃}) | (d_{C}_{₂},ₜ_{₃}, θ_{C}_{₂},ₜ_{₃}) | (d_{C}_{₃},ₜ_{₃}, θ_{C}_{₃},ₜ_{₃}) |
| t₄ | (d_{C}_{₁},ₜ_{₄}, θ_{C}_{₁},ₜ_{₄}) | (d_{C}_{₂},ₜ_{₄}, θ_{C}_{₂},ₜ_{₄}) | (d_{C}_{₃},ₜ_{₄}, θ_{C}_{₃},ₜ_{₄}) |
| t₅ | (d_{C}_{₁},ₜ_{₅}, θ_{C}_{₁},ₜ_{₅}) | (d_{C}_{₂},ₜ_{₅}, θ_{C}_{₂},ₜ_{₅}) | (d_{C}_{₃},ₜ_{₅}, θ_{C}_{₃},ₜ_{₅}) |

Table 1 shows the data store in the central node. For each camera Cᵢ and instant of time tⱼ the depth d_{C}_{ᵢ}_{,t}_{ⱼ} as well as the angle θ_{C}_{ᵢ}_{,t}_{ⱼ} of the object with respect to the camera are stored. If the camera is taking a picture and it doesn't detect any face in his field of view (FOV) it specifies this case by storing the value 0.

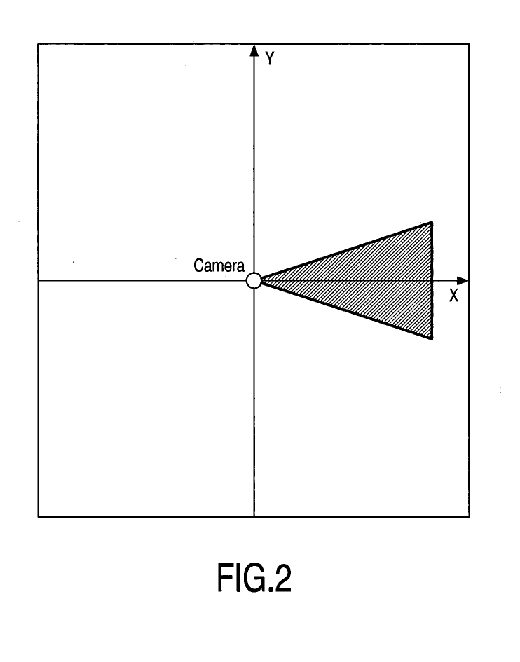

To build a 2D map of the network it is necessary to know the relative position of the cameras. To find this information, the first step is to specify a Cartesian plane with an origin point O of position (0,0). This point will be associated to the position of one camera. With this starting point and the data received from the cameras the central node will be able to attain the relative positions of the other cameras. The first camera chosen to start the computation is placed in the point (0,0) with the orientation versus the positive x-axis as depicted in FIG. 2. The positions of the other cameras will be found from that point and orientation.

The central node can now build a table to specify which cameras are already localized in the network as shown in the localization Table 2. This example shows the localization table when the algorithm starts, so no camera has a determined position and orientation in the Cartesian plane yet.

TABLE 2
Localization table for cameras C₁,_{C}₂,_{C}₃

| Cᵢ | localized | position | orientation |
|---|---|---|---|
| C₁ | no | (x_{C}_{₁}, y_{C}_{₁}) | φ_{C}_{₁} |
| C₂ | no | (x_{C}_{₂}, y_{C}_{₂}) | φ_{C}_{₂} |
| C₃ | no | (x_{C}_{₃}, y_{C}_{₃}) | φ_{C}_{₃} |

If the camera Cᵢ is localized, the position (x_{C}_{ᵢ},y_{C}_{ᵢ}) and the orientation φ_{C}_{ᵢ} in the Cartesian plane is known and the associated field localization is put to the value “yes” otherwise the fields position and orientation have no meaning and the value of “localized” is put to “no”.

After receiving the data and building the localization table the central node executes the following iterative algorithm:

1. In a first step, the algorithm starts searching for a camera not localized in the map. The camera must share at least three points (as proven after the description of the algorithm) with another camera that is already localized. If no camera is localized yet a camera is selected that is selected as a reference to define the Cartesian plane as previously shown in FIG. 2. According to this definition the origin of the Cartesian plane is the position of the selected reference camera, and the direction of the x-axis coincides with the orientation of the reference camera.

Control flow then continues with step 2.

If all smart cameras are localized, the algorithm is terminated, otherwise a camera Cᵢ is chosen that satisfies the previous requirement and the algorithm returns to step 3. If no one of these conditions is met, another stream of object points is taken and the entire algorithm is repeated.

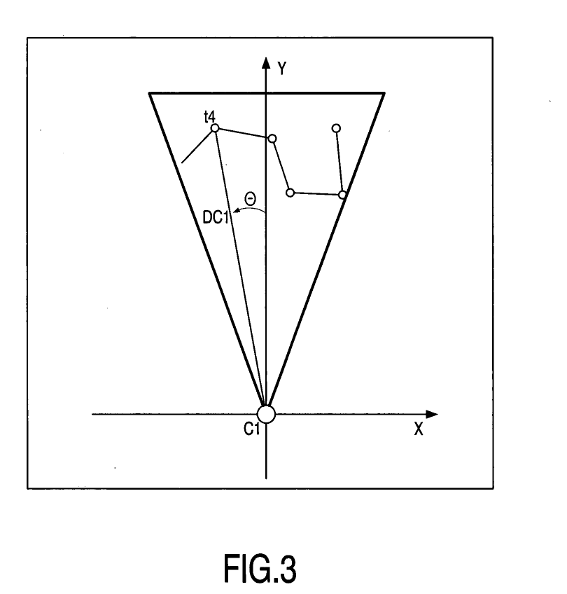

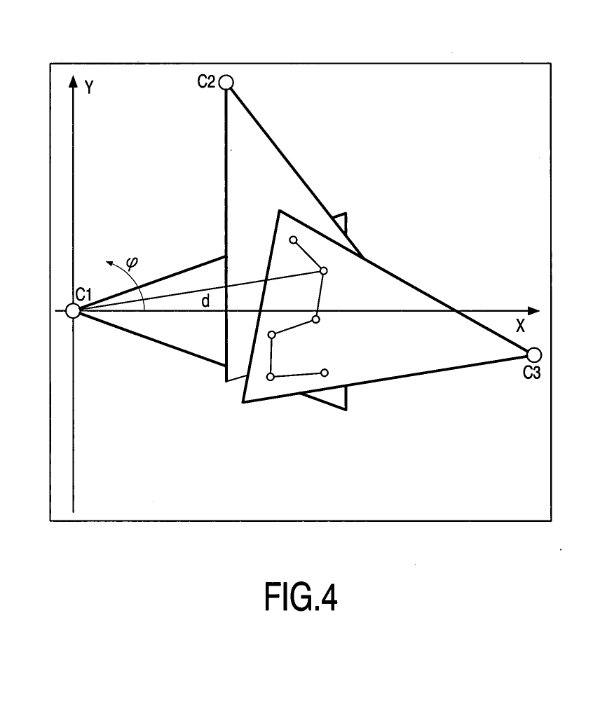

2. The second step is to change coordinates from Local Space (camera space), where the points of the object are defined relative to the camera's local origin (FIG. 3), to World Space (Cartesian plane) where vertices are defined relative to an origin common to all the cameras in the map (FIG. 4).

Now the position of the chosen camera Ci is fixed, and it is possible to fix the positions of the object seen by Ci in the Cartesian system. These coordinates are saved in the World object space table as depicted in Table 3. These positions (xₜ_{ⱼ},yₜ_{ⱼ}) are simply computed. In fact the depth between the local space and the world space remains the same because the camera is in the origin of both spaces. Also the angle is similar for the local space because the orientation of the camera is equal to zero φ_{C}_{ᵢ}=0 in the World Space, so:

xₜ_{ⱼ}=d_{C}_{ᵢ}_{,t}_{ⱼ} cos(θ_{C}_{ᵢ}_{,t}_{ⱼ})

yₜ_{ⱼ}=d_{C}_{ᵢ}_{,t}_{ⱼ} sin(θ_{C}_{ᵢ}_{,t}_{ⱼ})

Control flow then continues with step 1.

TABLE 3
Map of object points in the Cartesian system

| tⱼ | World coordinates |
|---|---|
| t₀ | (xₜ_{₀},yₜ_{₀}) |
| t₁ | (xₜ_{₁},yₜ_{₁}) |
| t₂ | (xₜ_{₂},yₜ_{₂}) |
| t₃ | (xₜ_{₃},yₜ_{₃}) |
| t₄ | (xₜ_{₄},yₜ_{₄}) |
| t₅ | (xₜ_{₅},yₜ_{₅}) |

Step 3: The camera Cₙ observes at least three world coordinates on the World Space. Assuming that these points are related to instants of time tᵢ, tⱼ, tₖ, from Table 3 the following coordinates are taken.

(xₜ_{ᵢ},yₜ_{ᵢ}); (xₜ_{ⱼ},yₜ_{ⱼ}); (xₜ_{ₖ},yₜ_{ₖ})

The resulting equations are simplified by using the following auxiliary terms.

a₁=2xₜ_{ⱼ}−2xₜ_{ᵢ}

b₁=2yₜ_{ⱼ}−2yₜ_{ᵢ}

c₁=xₜ_{ⱼ}²+yₜ_{ⱼ}²−d_{C}_{ₙ}_{,t}_{ⱼ}²−xₜ_{ᵢ}²−yₜ_{ᵢ}²−d_{C}_{ₙ}_{,t}_{ᵢ}²

a₂=2xₜ_{ₖ}−2xₜ_{ⱼ}

b₂=2yₜ_{ₖ}−2yₜ_{ⱼ}

c₂=xₜ_{ₖ}²+yₜ_{ₖ}²−d_{C}_{ₙ}_{,t}_{ₖ}²−xₜ_{ᵢ}²−yₜ_{ᵢ}²−d_{C}_{ₙ}_{,t}_{ᵢ}²

The position (x_{C}_{ₙ},y_{C}_{ₙ}) of camera with index n can now be computed using the following equations:

$$\begin{matrix}{x}_{{C}_{n}} = \frac{{b}_{2} {c}_{1} - {b}_{1} {c}_{2}}{{a}_{1} {b}_{2} - {b}_{1} {a}_{2}} , \\ and & ( 1 ) \\ {y}_{{C}_{n}} = \frac{{a}_{1} {c}_{2} - {a}_{2} {c}_{1}}{{a}_{1} {b}_{2} - {b}_{1} {a}_{2}} & ( 2 )\end{matrix}$$

subsequently, the orientation φ_{C}_{ₙ} of the camera n can be computed by applying the following formulas. There is an asymmetry between the formulas 3 and 4 in the paper

$$\begin{matrix}x = ( {x}_{{t}_{i}} - {x}_{{C}_{n}} ) cos ( - {θ}_{{C}_{n} , {t}_{i}} ) - ( {y}_{{t}_{i}} - {y}_{{C}_{n}} ) sin ( - {θ}_{{C}_{i} , {t}_{i}} ) & ( 3 ) \\ y = ( {y}_{{t}_{i}} - {y}_{{C}_{n}} ) cos ( - {θ}_{{C}_{n} , {t}_{i}} ) - ( {x}_{{t}_{i}} - {x}_{{C}_{n}} ) sin ( - {θ}_{{C}_{i} , {t}_{i}} ) & ( 4 ) \\ {ϕ}_{{C}_{n}} = arctan ( \frac{y}{x} ) & ( 5 )\end{matrix}$$

The function arc tan (y/x) is preferably implemented as Lookup Table(LuT), but may alternatively be calculated by a series development for example.

For x= 0, the arctan (y/x) is equal to π/2 or −π/2 if y is respectively positive or negative.

Subsequently the values obtained by the equations 1, 2, 5 are stored in the Localization table 2 and control flow continues with Step 1.

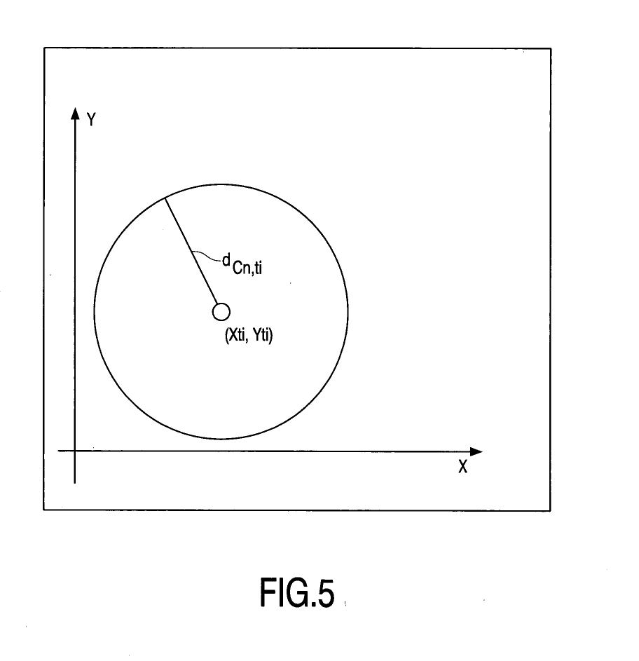

With reference to FIGS. 5, 6 and 7 a proof is given for the method according to the invention.

FIG. 5 shows that having one point (xₜ_{ᵢ},yₜ_{ᵢ}) and the relative distance between this point and the camera Cₙ is not enough to locate the camera in space. In fact, the points that satisfy the distance d d_{C}_{ₙ}_{,t}_{ᵢ} are the points of a circumference, described by Equation 6.

(x−xₜ_{ᵢ})²+(y−yₜ_{ᵢ})²=d_{C}_{ₙ}_{,t}_{ᵢ} (6)

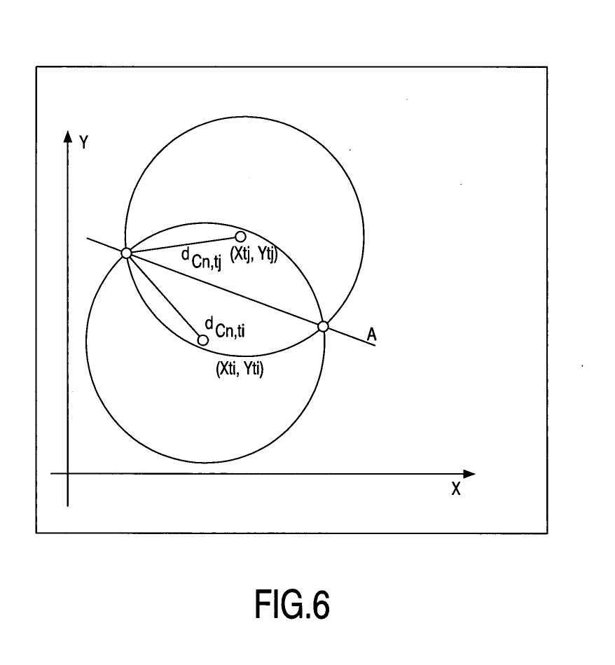

When two reference points (xₜ_{ᵢ},yₜ_{ᵢ}), (xₜ_{ⱼ},yₜ_{ⱼ}) are available as shown in FIG. 6, the solutions are given by the following system of equations:

(x−xₜ_{ᵢ})²+(y−yₜ_{ᵢ})²=d_{C}_{ₙ}_{,t}_{ᵢ} (7a)

(x−xₜ_{ⱼ})²+(y−yₜ_{ⱼ})²=d_{C}_{ₙ}_{,t}_{ᵢ} (7b)

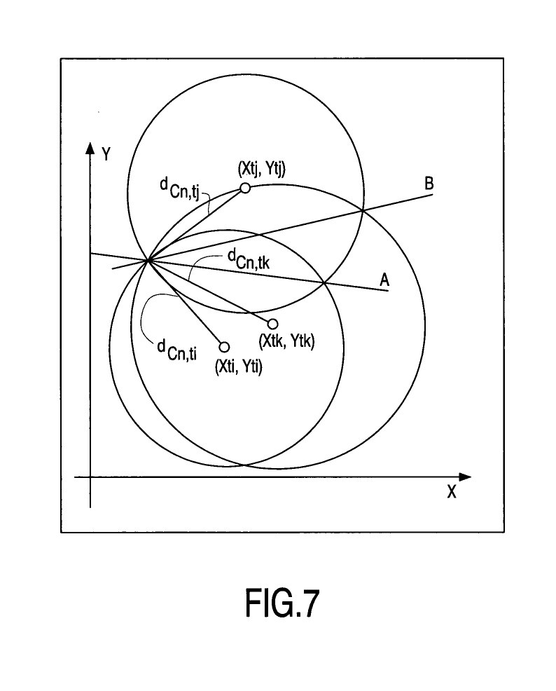

As illustrated by FIG. 7, a unique solution can be found when three reference points (xₜ_{ᵢ},yₜ_{ᵢ}), (xₜ_{ⱼ},yₜ_{ⱼ}),(xₜ_{ₖ},yₜ_{ₖ}) are available:

The unique solution is found from the following system of three equations:

(x−xₜ_{ᵢ})²+(y−yₜ_{ᵢ})²=d_{C}_{ₙ}_{,t}_{ᵢ} (8a)

(x−xₜ_{ⱼ})²+(y−yₜ_{ⱼ})²=d_{C}_{ₙ}_{,t}_{ᵢ} (8b)

(x−xₜ_{ₖ})²+(y−yₜ_{ₖ})²=d_{C}_{ₙ}_{,t}_{ₖ} (8c)

This system could be computational expensive, but it can be simplified as follows. Subtracting equation 8b from equation 8a a straight line A is obtained as depicted in FIG. 7. By subtracting equation 8c from equation 8b the straight line B is obtained.

Now, it suffices to solve the following system of two linear equations.

x(2xₜ_{ⱼ}−2xₜ_{ᵢ})+y(2yₜ_{ⱼ}−2yₜ_{ᵢ})+xₜ_{ᵢ}²+yₜ_{ᵢ}²−xₜ_{ⱼ}²−−yₜ_{ⱼ}²−d_{C}_{ₙ}_{,t}_{ᵢ}²−d_{C}_{ₙ}_{,t}_{ⱼ}=0 (9a)

x(2xₜ_{ₖ}−2xₜ_{ⱼ})+y(2yₜ_{ₖ}−2yₜ_{ⱼ})+xₜ_{ⱼ}²+yₜ_{ⱼ}²−xₜ_{ₖ}²−−yₜ_{ₖ}²−d_{C}_{ₙ}_{,t}_{ⱼ}²−d_{C}_{ₙ}_{,t}_{ₖ}=0 (9b)

By way of example it is assumed that the respective reference points are subsequent portions of a characteristic feature of a moving object. The characteristic feature may for example be the center of mass of said object, or a corner in the object.

Although it is sufficient to use three points for this calculation, the calculation may alternatively be based on a higher number of points. For example a first sub-calculation for the relative position may be based on a first, second and third reference point. Then a second sub-calculation is based on a second, a third and a fourth reference point. Subsequently a final result is obtained by averaging the results obtained from the first and the second sub-calculation.

Alternatively the first and the second sub-calculation may use independent sets of reference points.

In again another embodiment the calculation may be an iteratively improving estimation of the relative position, by each time repeating an estimation of the relative position of the cameras with a sub-calculation using three reference points and by subsequently calculating an average value using an increasing number of estimations.

In again another embodiment, the cameras may be moving relative to each other. In that case the relative position may be reestimated at a periodic time-intervals. Depending on the accuracy the results of the periodic estimations may be temporally averaged.

For example when subsequent estimations at points in time “i” are:

(x_{c,i},y_{c,i}), then the averaged value may be

$$( {x}_{c , k} , {y}_{c , k} ) = {\sum }_{m = - M}^{+ M} ( {x}_{c , k - m} , {y}_{c , k - m} )$$

The skilled person can choose an optimal value for M, given the accuracy with which the coordinates and the distances of the reference points with reference to the camera are determined and the speed of change of the relative position of the cameras.

For example, a relatively large value for M can be chosen if the relative position of the cameras changes relatively slowly.

Alternatively an average position (x_{c,k},y_{c,k}) can be calculated from sub-calculated coordinate pairs (x_{c,i},y_{c,i}) by an iterative procedure:

(x_{c,k},y_{c,k})=α(x_{c,k-1},y_{c,k-1})+(1−α)(x_{c,i},y_{c,i})

Likewise, the skilled person can choose an optimal value for α, given the accuracy with which the coordinates and the distances of the reference points with reference to the camera are determined and the speed of change of the relative position of the cameras. For example, a relatively large value for a can be chosen if the relative position of the cameras changes relatively slowly.

In the embodiment of the present invention height information is ignored. Alternatively the relative position of two cameras may be calculated using 3D-information. In that case the relative position of the cameras may be determined in an analogous way using four reference points.

The method according to the invention is applicable to an arbitrary number of cameras. The relative position of a set cameras can be computed if the set of cameras can be seen as a sequence of cameras wherein each subsequent pair shares three reference points.

It is remarked that the scope of protection of the invention is not restricted to the embodiments described herein. Parts of the system may implemented in hardware, software or a combination thereof. E.g. the algorithm for calculating the camera positions may be carried out by a general purpose processor or by dedicated hardware. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general purpose processor. The invention resides in each new feature or combination of features.

1. Method for determining a relative position of a first camera with respect to a second camera, comprising the followings steps:
Determining at least a first, a second and a third position of respective reference points with respect to the first camera
Determining at least a first, a second and a third distance of said respective reference points with respect to the second camera
Calculating the relative position of the second camera with respect to the first camera using at least the first to the third positions and the first to the third distances.

2. Camera arrangement comprising a first camera, a second camera and a control node, which control node is coupled to the first camera to receive a first, a second and a third position ((xₜ_{ᵢ},yₜ_{ᵢ}); (xₜ_{ⱼ},yₜ_{ⱼ}); (xₜ_{ₖ},yₜ_{ₖ})) of respective reference points with respect to the first camera, and coupled to the second camera to receive a first, a second and a third distance (d_{C}_{ᵢ}_{,t}_{ᵢ}, d_{C}_{ᵢ}_{,t}_{ⱼ}, d_{C}_{ᵢ}_{,t}_{ₖ}) of said respective reference points with respect to the second camera, which control node is further arranged to calculate a relative position of the second camera (x_{C}_{₂},y_{C}_{₂}) with respect to the first camera based on the first to the third positions and the first to the third distances.

3. Camera arrangement according to claim 2, wherein the cameras are smart cameras.

4. Camera arrangement according to claim 2, wherein the control node is further arranged to calculate a relative orientation (φ_{C}_{ₙ}) of the second camera with respect to the first camera.
